(19) United States
(12) Patent Application Publication
(10) Pub. No.: US 2022/0069431 A1
(43) Pub. Date: Mar. 3, 2022

(54) Satellite Dish Mounting Plate

(71) Applicant: Benjamin Stuebs, Homosassa, FL (US)

(72) Inventor: Benjamin Stuebs, Homosassa, FL (US)

(21) Appl. No.: 17/009,794

(22) Filed: Sep. 2, 2020

(51) Int. Cl. H01Q 1/12; E04D 13/00

(52) U.S. Cl. CPC H01Q 1/1214; E04D 13/00

(57) ABSTRACT

The satellite dish baseplate serves as a support panel integrated into plywood and installed on the roof of a home to provide simpler stationing of a direct-to-home satellite. Particularly when new houses are being built, the baseplate can be utilized for either eastern or western satellites. Such satellites can be attached or detached from the baseplate. The plate comes with all the necessary threaded holes and additionally has a cover for when the baseplate is not in use by a satellite dish.

### BACKGROUND

A satellite dish is a dish-shaped type of parabolic antenna designed to receive or transmit information by radio waves to or from a communication satellite. The term most commonly means a dish used by consumers to receive direct-broadcast satellite television from a direct broadcast satellite in geostationary orbit. There have been no products available as original equipment or as an aftermarket to address this problem.

Direct-To-Home can either refer to the communications satellites themselves that deliver service or the actual television service. Most satellite television customers in developed television markets get their programming through a direct broadcast satellite provider. Signals are transmitted using Kᵤ band and are completely digital which means it has high picture and stereo sound quality. Programming for satellite television channels comes from multiple sources and may include live studio feeds. The broadcast center assembles and packages programming into channels for transmission and, where necessary, encrypts the channels. The signal is then sent to the uplink where it is transmitted to the satellite. There have been no products available as original equipment or as an aftermarket to address this problem either.

There exists a need for a satellite dish baseplate that is not being met by any known or disclosed device or system of present.

### SUMMARY OF THE INVENTION

The satellite dish mounting plate serves as a support panel integrated into plywood and installed on the roof of a home to provide simpler stationing of a direct-to-home satellite. Particularly when new houses are being built, the mounting plate, also known as a baseplate, can be utilized for either eastern or western satellites. Such satellites can be attached or detached from the baseplate. The plate comes with all the necessary threaded holes and additionally has a cover for when the baseplate is not in use by a satellite dish.

### BRIEF DESCRIPTION OF THE DRAWINGS

FIG. 1 is an exploded view from above of the first design of the satellite dish baseplate and cover in accordance with an embodiment of the present disclosure.

FIG. 2 is a view from above of the second design of the satellite dish baseplate in accordance with an embodiment of the present disclosure.

FIG. 3 is a bottom view of the second design for the satellite dish baseplate in accordance with an embodiment of the present disclosure.

FIG. 4 is a perspective view of a cover for the satellite baseplate in accordance with an embodiment of the disclosure.

FIG. 5 is a flow chart of a method of installation of the predefined mounting plate in accordance with an embodiment of the present disclosure.

FIG. 6 is a flow chart of a further method of installation of the predefined mounting plate in accordance with an embodiment of the disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the terms mounting plate, baseplate and rigid plate are used synonymously to refer to the hardware used to mount a satellite dish foot plate onto a roof of a structure. The term lag refers to a lag screw used for securing the rigid plate onto a roof and the term stud refers to a stud bolt used for installing the satellite foot plate onto the rigid plate.

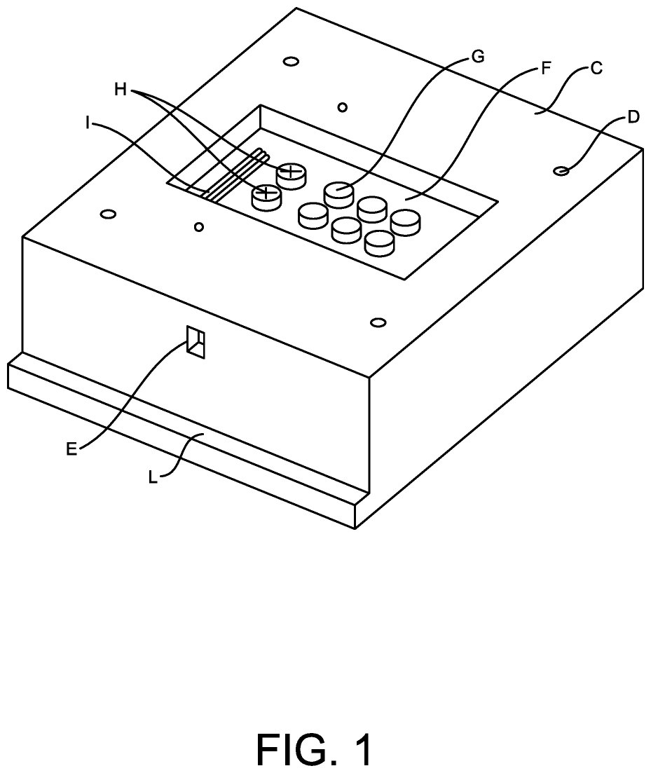

FIG. 1 is an exploded view from above of the first design of the satellite dish baseplate and cover in accordance with an embodiment of the present disclosure. On two sides of the baseplate cover A are latches B that connect to the plate for when a satellite is not attached. The baseplate C has the dimensions to be integrated to roof plywood with a size of eight inches long, by seven and one-half inches wide, by three inches tall. On the top face of the plate are four threaded holes D for removable three-eights inch studs. These threaded holes are positioned on the plate toward the corner edges of the top face. On two of the side faces opposite to each other and matching with the cover latch positions are latch holes E for the cover latches to fit into. On the top face of the plate, centered on the middle is a rectangular compartment F, that holds nylon lock nuts G and lags installed by the roofers H. Towards the edge of the inside of said compartment is a place for spare studs I. A flange L shown projecting from a backside of the rigid plate, facilitates mounting into a hole defined in a sheet of plywood. The flange may project from one side or from all sides of the rigid plate according to need.

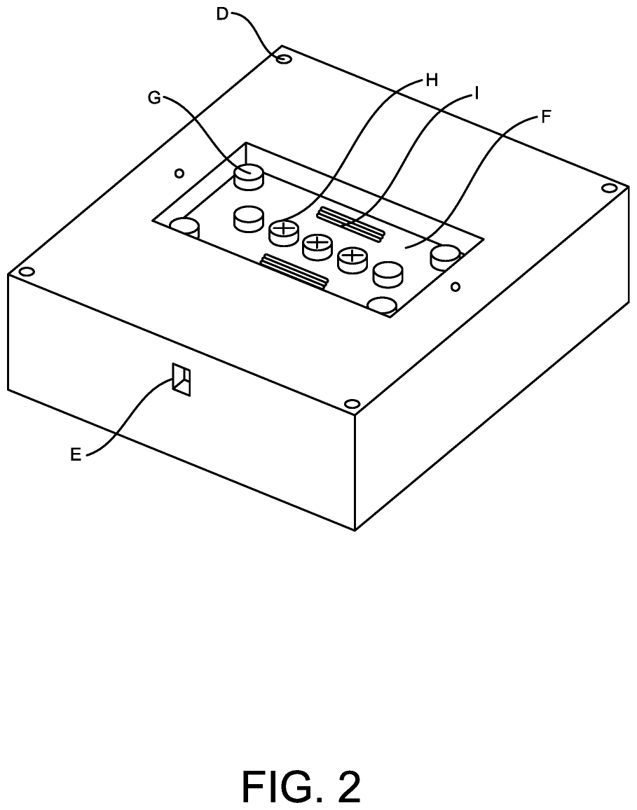

FIG. 2 is a view from above of the second design of the satellite dish baseplate in accordance with an embodiment of the present disclosure. In this design, the threaded holes D on the front face are closer to the four corners than in the first design. Furthermore, the lags H installed by the roofers are in the center of the compartment F, and the nylon lock nuts G surround said lags.

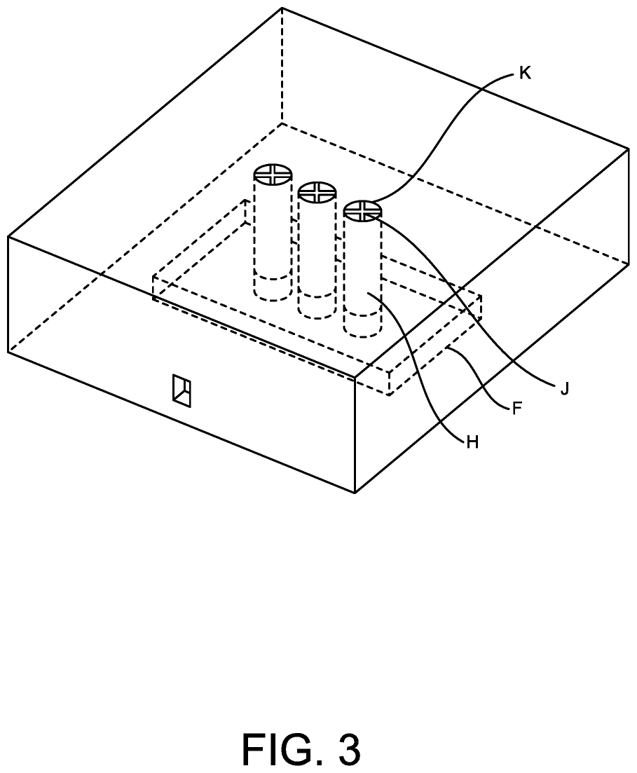

FIG. 3 is a bottom view of the second design for the satellite dish baseplate in accordance with an embodiment of the present disclosure. It is depicted how the holes J for the lags go through the entire baseplate and allow for the lags to go through into the truss. On the bottom side, there are also grommets K for said lags.

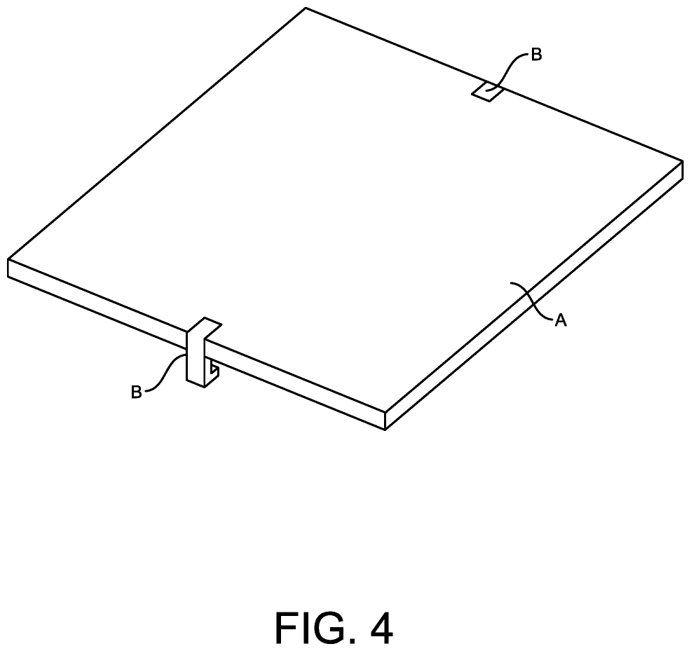

FIG. 4 is a perspective view of a cover for the satellite baseplate in accordance with an embodiment of the disclosure. The view includes the cover A and the latches B for attaching and securing the cover A to the rigid plate.

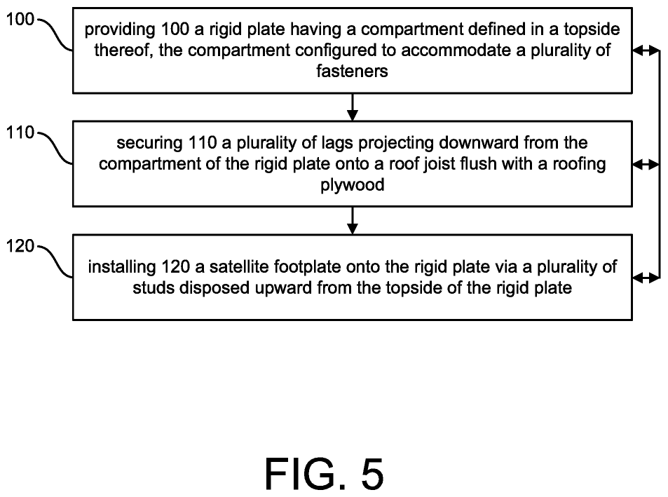

FIG. 5 is a flow chart of a method of installation of the predefined mounting plate in accordance with an embodiment of the present disclosure. The method of mounting a plate system includes providing 100 a rigid plate having a compartment defined in a topside thereof, the compartment configured to accommodate a plurality of fasteners. The method also includes securing 110 a plurality of lags projecting downward from the compartment of the rigid plate onto a roof joist flush with a roofing plywood. The method additionally includes installing 120 a satellite footplate onto the rigid plate via a plurality of studs disposed upward from the topside of the rigid plate.

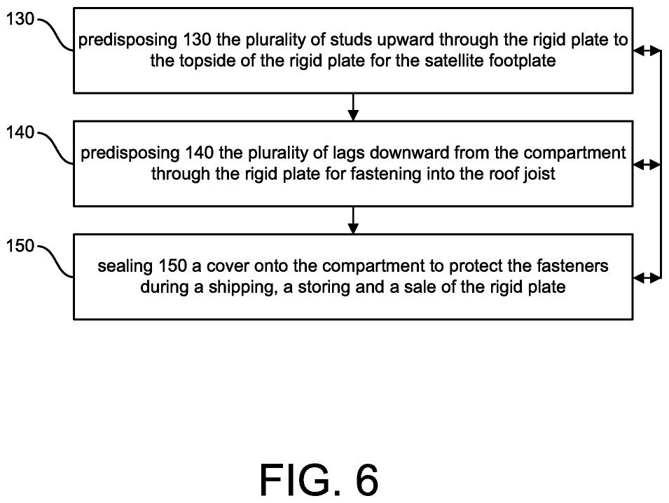

FIG. 6 is a flow chart of a further method of installation of the predefined mounting plate in accordance with an embodiment of the disclosure. The method further includes predisposing 130 the plurality of studs upward through the rigid plate to the topside of the rigid plate for the satellite footplate. The method yet includes predisposing 140 the plurality of lags downward from the compartment through the rigid plate for fastening into the roof joist. Embodiments of the method include sealing 150 a cover onto the compartment to protect the fasteners during a shipping, a storing and a sale of the rigid plate.

Further embodiments of the method include installing the rigid plate into a complementary opening defined in a backside of a sheet of roofing plywood against a flange of the rigid plate, storing an excess of the plurality of fasteners in the compartment and sealing the rigid plate flush with a sheet of roofing plywood. The method yet includes sealing a cover over the compartment during an installation and a use of the rigid plate.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention.

Accordingly, it is not intended that the disclosure be limited, except as by the specification and claims set forth herein.

What is claimed is:

1. A mounting plate comprising:
a rigid plate having a thickness and a compartment defined in the thickness, the compartment configured to accommodate a plurality of fasteners;
a plurality of stud holes defined in the rigid plate, the plurality of stud holes configured to accommodate a plurality of studs configured to secure a satellite foot plate onto the rigid plate; and
a plurality of lag holes defined in the rigid plate, the plurality of lag holes configured to accommodate a plurality of lags configured to secure the rigid plate into a roof joist.

2. The mounting plate of claim 1, further comprising a cover for the compartment of the rigid plate, the cover latchable thereon.

3. The mounting plate of claim 1, further comprising a latch hole defined in the mounting plate.

4. The mounting plate of claim 1, further comprising a plurality of latches configured to fasten a cover onto the compartment of the rigid plate.

5. The mounting plate of claim 1, wherein a location of the plurality of stud holes are predefined to match a location of mounting holes in a satellite foot plate.

6. The mounting plate of claim 1, wherein a location of the plurality of lag holes are predefined in a column complementary to a roof joist.

7. The mounting plate of claim 1, wherein the plurality of fasteners include the plurality of studs, the plurality of lags and a plurality of lock nuts.

8. The mounting plate of claim 1, wherein the thickness of the rigid plate is equivalent to a thickness of a sheet of roofing plywood.

9. The mounting plate of claim 1, further comprising a flange on the rigid plate, the flange configured to partially overlap a hole defined in a sheet of roofing plywood to accept the rigid plate.

10. A mounting plate system comprising:
a rigid plate having a thickness and a compartment defined in a topside of the rigid plate, the compartment configured to accommodate a plurality of fasteners;
a plurality of studs projecting upward from the topside of the rigid plate, the plurality of studs prelocated to secure a satellite foot plate onto the topside of the rigid plate; and
a plurality of lags projecting downward from the compartment of the rigid plate, the plurality of lags prelocated to secure the rigid plate onto a roof joist flush with a roofing plywood.

11. The mounting plate system of claim 10, further comprising a cover for the compartment, the cover attachable to the rigid plate.

12. The mounting plate system of claim 10, further comprising a flange configured to extend from a backside of the rigid plate opposite the topside.

13. A method of mounting a plate system comprising:
providing a rigid plate having a compartment defined in a topside thereof, the compartment configured to accommodate a plurality of fasteners;
securing a plurality of lags projecting downward from the compartment of the rigid plate onto a roof joist flush with a roofing plywood; and
installing a satellite footplate onto the rigid plate via a plurality of studs disposed upward from the topside of the rigid plate.

14. The method of claim 13, further comprising predisposing the plurality of studs upward through the rigid plate to the topside of the rigid plate for the satellite footplate.

15. The method of claim 13, further comprising predisposing the plurality of lags downward from the compartment through the rigid plate for fastening into the roof joist.

16. The method of claim 13, further comprising sealing a cover onto the compartment to protect the fasteners during a shipping, a storing and a sale of the rigid plate.

17. The method of claim 13, further comprising installing the rigid plate into a complementary opening defined in a backside of a sheet of roofing plywood against a flange of the rigid plate.

18. The method of claim 13, further comprising storing an excess of the plurality of fasteners in the compartment.

19. The method of claim 13, further comprising sealing the rigid plate flush with a sheet of roofing plywood.

20. The method of claim 13, further comprising sealing a cover over the compartment during an installation and a use of the rigid plate.
